(19) United States
(12) Patent Application Publication
(10) Pub. No.: US 2009/0003270 A1
(43) Pub. Date: Jan. 1, 2009

(54) Server-Driven Progressive Image Transmission

(76) Inventors: Derek L. Schwenke, Marlboro, MA (US); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/770,874

(22) Filed: Jun. 29, 2007

(51) Int. Cl. H04L 29/06

(52) U.S. Cl. 370/329

(57) ABSTRACT

A system and method generates a progressive codestream representing an image. The codestream of packets representing an image is parsed to obtain a parsed packets and metadata for each parsed packet. The parsed packets are decomposed to decomposed packets according to the metadata and a progressive transmission policy. The decomposed packets are assigned to sequentially arranged segments according to the metadata and the transmission policy, in which each segment includes a header, and in which an ordering of the packet in the codestream is different than an ordering of the decomposed packets in the plurality of segments. A client composes the decomposed packets according to the header in the segments to progressively reconstruct the image in the client.

### FIELD OF THE INVENTION

The invention relates generally to image and video transmission, and more particularly to server-side progressive image transmission.

### BACKGROUND OF THE INVENTION

Video surveillance, cellular telephones, digital cameras, printers, scanners, facsimile, copiers, medical imaging, satellite imaging, the Internet, and compound documents, have increased the demand for image and video applications. However, due to limiting resources, such as memory, processors, and network bandwidth, storing, processing, transmitting, and rendering high quality images is often not possible.

The quality of an image depends on the number of pixels in the image, and the number of bits that are allocated to each pixel. For example, an image with 1024×1024 pixels, 24 bits for each pixel is a 25 Mb high quality color image, while a 10×10 pixel image with 1 bit per pixel is a 100 bit low quality black and white image. Here, the quality difference is more than five orders of magnitude.

Compression standards, such as JPEG 2000, see ISO/IEC 1.5444-1, “Information technology . . . JPEG 2000 image coding system . . . Part 1; Core coding system,” 1^{st} Ed., 2000, and D. Taubman, M. Marcellin, “JPEG 2000: Image Compression Fundamentals, Standards and Practice,” Kluwer Academic Publishers, Boston, 2002, have been designed in a scalable manner so that different qualities, resolutions, components and positions of image data can easily be stored, processed, transmitted, and rendered. JPEG 2000 uses a wavelet-based compression technique.

JPEG 2000 operates at higher compression ratios than the original DCT-based JPEG standard, without generating aliasing artifacts. JPEG 2000 also enables progressive downloads. An image is partitioned into tiles. A two-dimensional wavelet transform is performed on each tile to produce a set of wavelet coefficients grouped into subbands at various resolutions. The wavelet transform coefficients are regrouped into “precincts.” The precincts enable access to spatial regions of the image. The precincts are partitioned into code-blocks for compression as a codestream.

The codestream includes marker segments for identifying the segments containing image data. A header contains information about the width and height of image components, and parameters describing how the compressed data should be decoded. The header is followed by tile-parts. The codestream contains all the entropy coded image data, and information indicating the method for decoding the data. The codestream also contains information about the wavelet transform used, the size of tiles, the precinct sizes, and the number of resolutions, and an order of packets. The codestream also includes packet length information that enables direct access to image data.

Progressive transmission of scalable encoded images as a codestream refers to a process by which some portions of the image are transmitted first. For example, a foreground region containing a person is transmitted before a background region. Other factors, such as quality and resolution can also be considered. For example, progressive quality is achieved by first transmitting coarsely quantized samples of the image, followed by refinements of the image samples. When network bandwidth is limited, this effectively enables the user to view a relatively low quality version of the image in a short amount of time. As more data are received, the image quality improves over time.

Progressive encoding and transmission of images is supported by the JPEG and JBIG file format standards, see A, N, Netravali, B. G. Haskell, “Digital Pictures—Representation and Compression,” 2nd edit,. New York, London: Plenum Press, 1995, and W. Pennebaker, J. Mitchell, “JPEG Still Image Data Compression Standard”, Van Nostrand Reinhold, New York, 1993. The ordering of the image is defined globally for the entire image. The standard only allows a limited number of possible progressive orders, and limits the effective applications where a single ordering is sufficient.

JPEG 2000 improves on the older JPEG file format standard with better compression and support for advanced features, such as flexible progressive order and image tiling. The progressive order is defined globally and locally for sections of the codestream by markers placed in the codestream. The markers indicate changes in the progressive order. However, the addition of the markers increases a size of the stream, and does not allow for independent control of every region of the image.

To reduce this problem, image tiling is used to partition the image into regions that are compressed independently. Then, the regions can be stored, processed, transmitted and rendered independently in a progressive manner. Image tiling also increases the size of the codestream. In applications where many tiles are required, the increase in size can be large. Also, tiling regions are restricted to rectangles with precinct aligned spatial partitioning of the image, which is only one style of progressive ordering.

The JPEG interactive protocol (JPIP) is standardized as Part 9 of the JPEG 2000 standard, see ISO/IEC 15444-9, “Information technology . . . JPEG 2000 image coding system . . . Part 9: Interactivity tools, APIs and protocols,” 1^{st} Ed., 2005, and D. Taubman, R. Prandolini, “Architecture, philosophy and performance of JPIP: internet protocol standard for JPEG2000,” Proc. SPIE Conf. on Visual Communications and Image Processing, SPIE volume 5150, pp. 649-663, 2003.

JPIP is a request-response protocol that enables client computers (clients) to select portions of an image for transmission from a server computer (server). As an advantage, each client can select the format of the image for specific application requirements. Specifically, each client makes one or more HTTP GET requests. The requests contain the name of the image resource and the query fields to request. The fields describe many possible image features such as layer, resolution, component, precinct, viewing window, session, cached data, etc. The protocol is performed in an interactive manner, whereby the client makes a request, receives some image data, and then the client decides what to request next. It is important to note that JPIP only defines an interaction protocol initiated by the client for the server, and not the operation of the client or the server. The processing and signaling overhead of this client-driven protocol is relatively high because bi-directional communication is needed. In JPIP, requests for coded image data originate at the client. Such interactivity is useful for remote browsing of very large images, as described by Taubman in “Remote Browsing of JPEG 2000 Images,” Proc. IEEE International Conference on Image Processing, vol. 1, pp. 229-232, 2002,

Interactive image browsing can also use byte ranging techniques, see Deshpande and Zeng, “Scalable streaming of JPEG 2000 images using hypertext transfer protocol,” Proc. ACM Multimedia, pp. 372-281, 2001. That method uses HTTP/1.1 for byte range access, and requires the transmission of index tables from which the client can infer the locations (byte ranges) of relevant compressed data and header information to be requested.

Much of the prior work on progressive Image transmission is client-driven, where interactive requests from a client guide the transmission of encoded images from the server to the client. However, there exist a number of progressive transmission applications that do not require client-driven requests. Therefore, there is a need for server-driven progressive image transmission that facilitates flexible progressions, and has minimal signaling overhead and processing requirements.

The following terms are defined by the JPEG 2000 specification and used herein:

Bit stream: The actual sequence of bits resulting from the coding of a sequence of symbols. It does not include the markers or marker segments in the main and tile-part headers or the EOC marker. It does include any packet headers and in stream markers and marker segments not found within the main or tile-part headers.

Codestream: A collection of one or more bit streams and the main header, tile-part headers, and the EOC required for their decoding and expansion into image data. This is the image data in a compressed form with all of the signaling needed to decode.

Compressed image data: Part or all of a bit stream. Can also refer to a collection of bit streams in part or all of a codestream.

Progression: The order of a codestream where the decoding of each successive bit contributes to a “better” reconstruction of the image. What metrics make the reconstruction “better” is a function of the application. Some examples of progression are increasing resolution or improved sample fidelity.

### SUMMARY OF THE INVENTION

A system and method generates a progressive codestream representing an image. The codestream of packets representing an image is parsed to obtain a parsed packets and metadata for each parsed packet.

The parsed packets are decomposed to decomposed packets according to the metadata and a progressive transmission policy.

The decomposed packets are assigned to sequentially arranged segments according to the metadata and the transmission policy, in which each segment includes a header, and in which an ordering of the packet in the codestream is different than an ordering of the decomposed packets in the plurality of segments.

A client composes the decomposed packets according to the header in the segments to progressively reconstruct the image in the client.

### BRIEF DESCRIPTION OF THE DRAWINGS

FIG. 1 is a block diagram of a server-driven progressive transmission method and system according to an embodiment of the invention;

FIG. 2 is a flow diagram of a codestream decomposition process according to an embodiment of the invention;

FIG. 3 is a block diagram of metadata according to an embodiment of the invention;

FIG. 4 is a block diagram of a format of a codestream according to an embodiment of the invention;

FIG. 5 is a flow diagram of a process for reconstructing a progressive codestream according to an embodiment: of the invention;

FIG. 6 is a block diagram of a segment list according to an embodiment of the invention;

FIG. 7-12 are block diagrams of codestreams according: to an embodiment of the invention; and

FIGS. 13A-13I are block diagrams of example progressions according to embodiments of the invention.

### DETAILED DESCRIPTION OF THE PREFERRED EMBODIMENT

Embodiments of our invention provide a method for generating and transmitting an image progressively from a server to a client. Our method is server-driven and does not require input from the client in order to operate. The invention facilitates a wide variety of progressions with minimal signaling overhead. The invention also enables incremental decoding and rendering of the reconstructed image at the client with minimal delay.

A key difference between our invention and the conventional JPIP protocol is the mode of interaction. JPIP is defined as a client-driven request-response protocol. In contrast, the method according to the invention provides the image to the client in a progressive order that is entirely prescribed by the server. With conventional JPIP, this could potentially require many thousands of requests by the client to achieve the same desired ordering. The invention, does require any request protocol at the client and does not add any transmission request overhead or round trip delay due to request-response pairs. The ordering of the codestream is determined entirely by the server, and/or an application executing on the server.

For an example in a face recognition application, a desired transmission order first transmits a region of interest (ROI) in the image that includes just the face, perhaps at a reduced quality. Then, a quality of the face in the region is improved in progressive layers over time. To achieve this with the conventional JPIP, the client first needs access to the entire image to determine the desired ordering of the codestream to be transmitted by the server to the client, which is not practical.

Method and System Overview

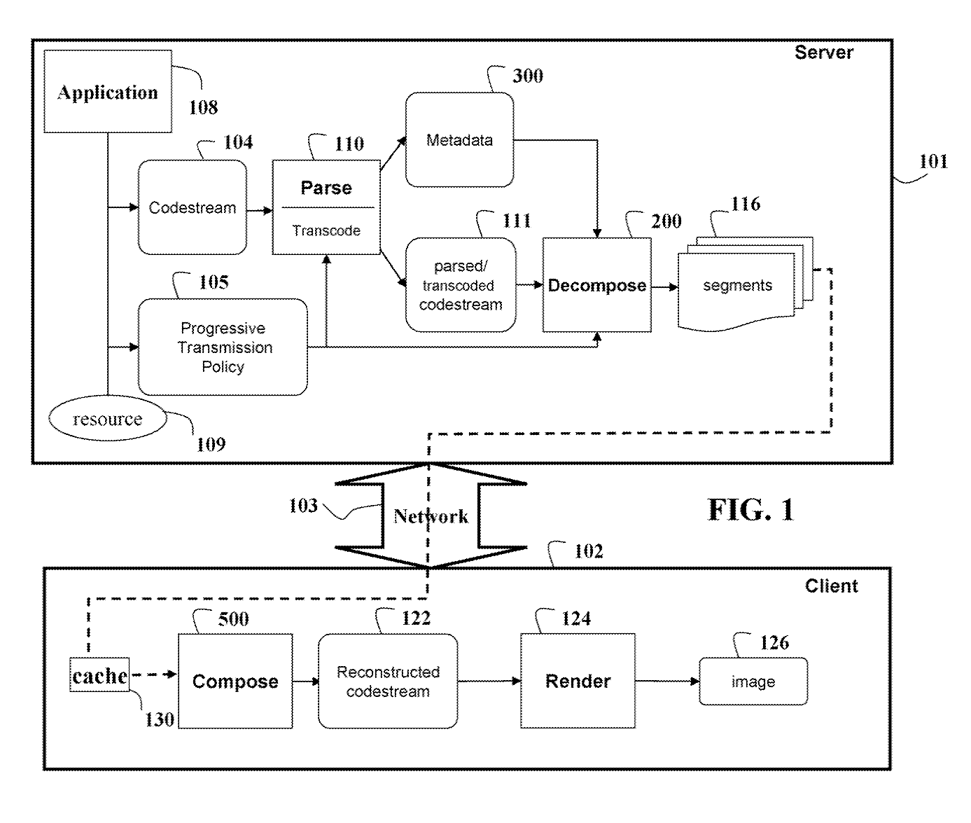

FIG. 1 shows a method and system for generating and transmitting an image progressively from a server 101 to a client 102 via a network 103 according to an embodiment of our invention. The method is server-driven.

Server

The server 101 includes a parser/transcoder 110 and a decomposer 500. The method is initiated at the server. Input to the method is a codestream 104 derived from one or more images, and a progressive transmission policy 105. The codestream can be a conventional JPEG 2000 codestream derived from some image. The codestream can be generated by a server application 108. The policy can be determined in part by the application. Other parts of the policy, which can relate to available system resources 109 (memory, buffers, bandwidth, etc.), can be determined by the server. The policy specifies a progressive transmission order of the packets to be transmitted as the segments 116, e.g., a header and JPEG 2000 packets of the corresponding segment. The transmission order can also be called the progressive transmission policy.

Transcoder

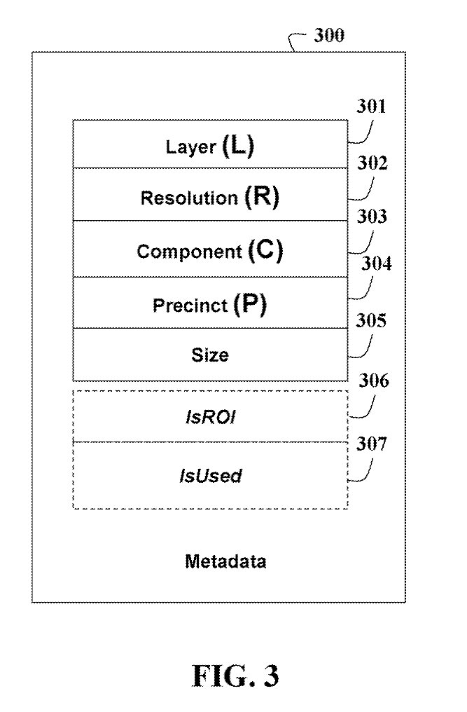

The parser/transcoder 110 produces a parsed codestream 111 and metadata 300, see FIG. 3. The input codestream 104 can also be transcoded according to the policy 105 and the metadata 300. The metadata indicates descriptive information about each packet in the parsed codestream.

The parsed codestream 111 is decomposed 115 according to the metadata 300 and the policy 105 to generate the segments 116. The segments 116 are transmitted progressively to the client 102 over the network 103.

The parsed/transcoded codestream 111 can have a reduced data rate, reduced quality, cropped image, or changed progressive order. Changing the progressive order is useful to reduce the complexity of the decomposing and to minimize overhead as is described in further detail below. Our method can use any known transcoder. A preferred transcoding method is described in U.S. Patent Publication 20060120610 “Image Transcoding,” incorporated herein by reference.

The segments 116 are portions of the parsed codestream that may be non-compliant with the JPIP standard. Each segment 116 contains one or more headers that provide descriptive information about the packets to be included in the segments.

Client

The segments 116 are received by the client 102. The segments can be stored in a cache 130 or memory buffer. A compose operation 500 reorders the packets received in the segments 116 and inserts empty packets, as needed, to reconstruct a conventional codestream 122. The compose process is invoked each time a new segment is received. The reconstructed codestream 122 can be rendered 124 to produce an image 126 for a user. Note, the numerical ordering of the packets during the reconstruction can be different than the original contiguous numerical ordering in the codestream.

Although our invention is described according to the JPEG 2000 specification, the invention applies more generally to any progressively encoded image or video.

Decompose

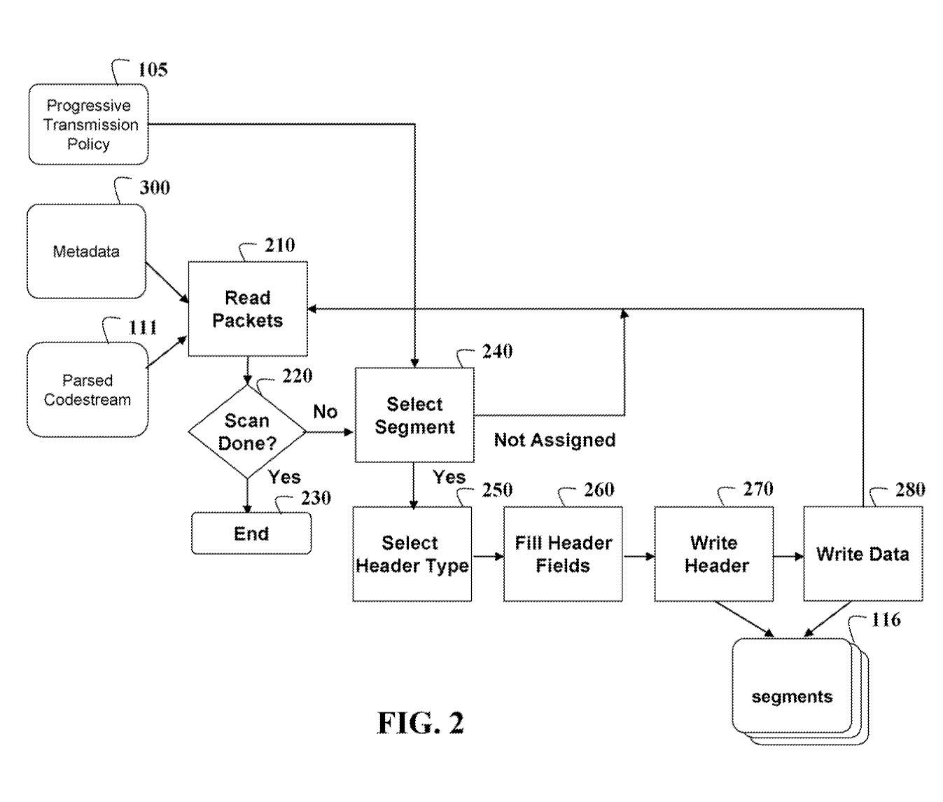

FIG. 2 is a flow diagram of the decompose operation 200. The decompose process operates according to the policy 105. The decompose process reads 210 packets of the parsed codestream 111, and the corresponding metadata 300. The packets are from a next contiguous portion of the codestream of any size. If the codestream has been completely processed, then the scan 220 is done 230.

If there are more packets, then the process selects 240 the next segment and assigns the packets of the segment to a segment 116 according to the policy 105. It may occur that the packets in a segment are not assigned to any segment. In this case, the segment is effectively discarded.

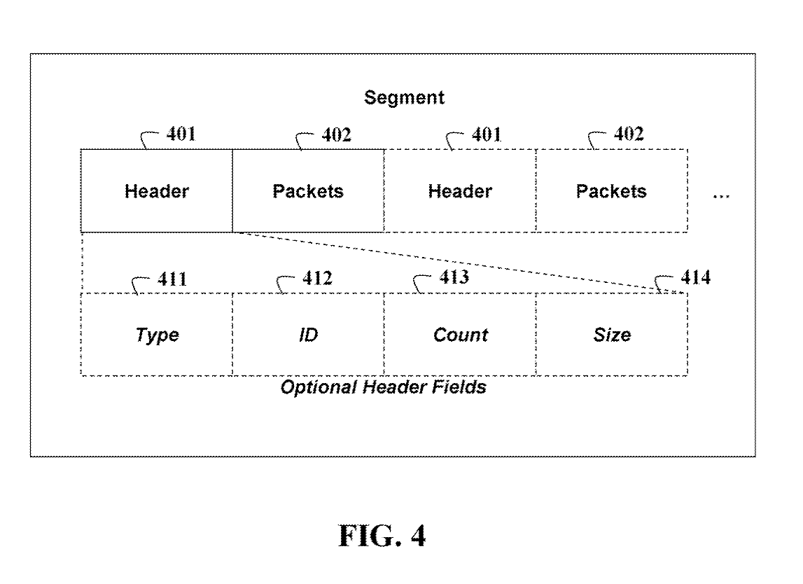

If the segment is to be included, then the process selects 250 the correct header type to describe this segment of codestream data. Next, the process determines 260 the fields of the header, see FIG. 4, and writes 270 the header for the segment 116. The packets of the segment are written 280 to the segment 116. Then, the process reads 210 the next segment.

FIG. 2 shows the generation of all segments 116 in one scan, i.e., a single traversal of the parsed codestream 111. However, the process can be modified to produce any number of segments in any number of scans.

The decompose process 200 provides a general solution for encoding any reordered codestream. Using this process, the order of progressive transmission and rendering can be changed, and packets corresponding to a particular quality layer, resolution level or component can be removed. In this way, progressive transmission of a spatial regions-of-interest can also be achieved.

Metadata

FIG. 3 shows a structure of the metadata 300. There is one block of metadata 300 for each packet in the parsed codestream 111. This information is internal to the server and is only used to decompose 200 the packets of the parsed codestream 111 and assign the decomposed packets to the segments 116.

The metadata include a quality layer index (L) 301, a resolution, level index (R) 302, a component index (C) 303, a precinct index (P) 304, and a data size in bytes 205. That is, the metadata are arranged in a hierarchical LRCP order. The optional IsROI bit 306 is true when the segment is part of an ROI region. The optional IsUsed bit 307 tracks the segments to be included in any segment 116.

Header

FIG. 4 shows the header for a segment 116. Each segment starts with a segment header 401, followed by segment packets 402, and possibly more headers 401 and more packets 402.

All or some fields of the header 401 can be omitted if they are not needed or can be predicted by the client. The first field is the “Type” 411, which signifies a type of the header, e.g., a long 12 Byte format or a short 6 Byte format, and indicates any omitted header fields. The “ID” 412 is an index for the packets in the segment. The “Count” 413 contains the number of sequential IDs that follow in the codestream data segment. The “Size” 414 is the number of bytes of the codestream packets that follow. These fields enable direct access to the packets, and reconstruction of a valid codestream that can be progressively decoded and rendered at the client.

Compose

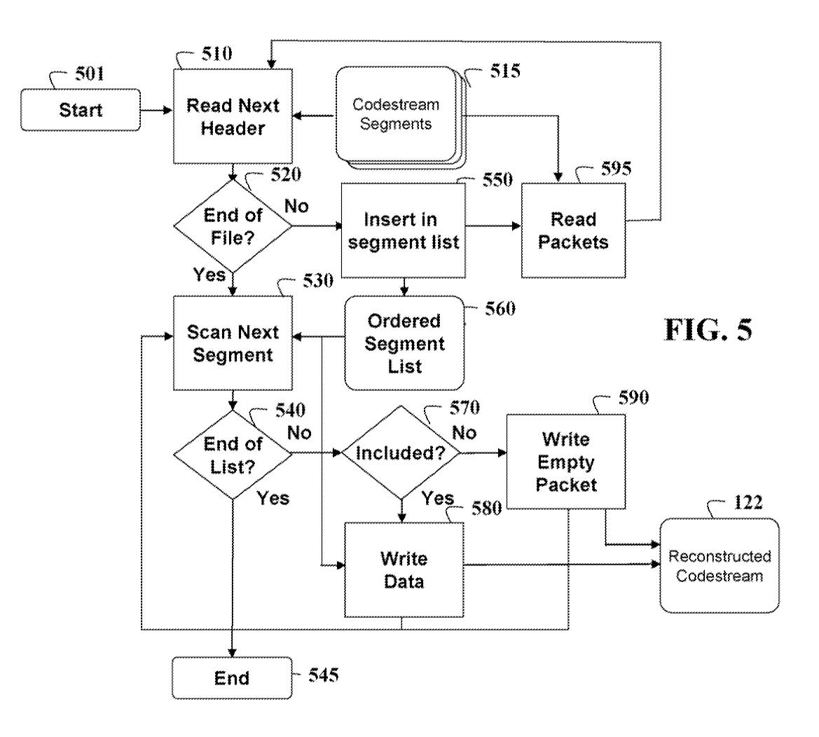

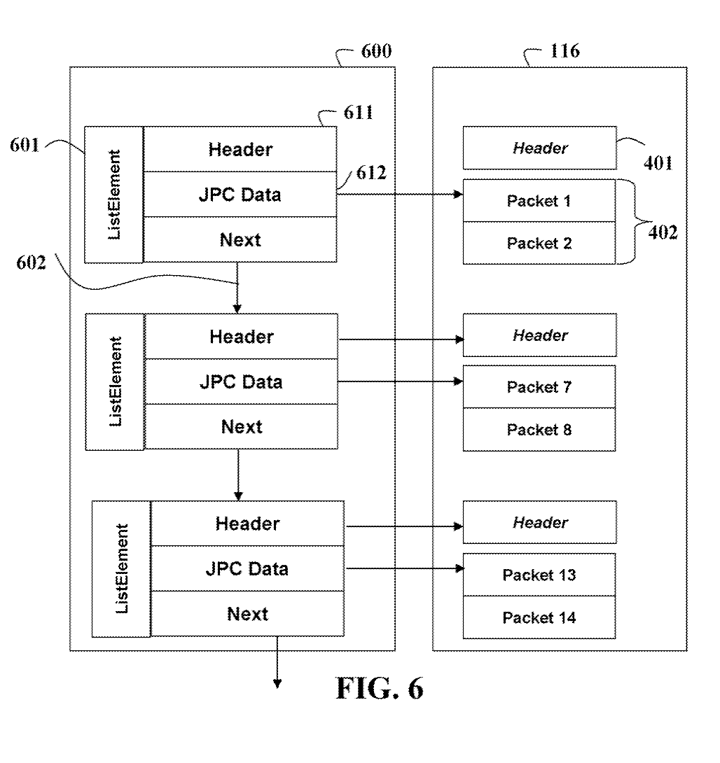

FIG. 5 is a flow diagram of the compose operation 500 at the client 102 beginning with start 501. The first phase of the compose operation reads the segments. If a valid header is read 510, the header is inserted 550 into an ordered list 600, see FIG. 6. Next, the packets of the segment are read 595 and inserted 550 in the ordered segment list 600. Then, the compose process attempts to read the next header. This continues until end of file 520 is encountered, and ail available headers and segments are read.

The second phase of the process generates the reconstructed codestream 122 from the ordered segment list 600. The process scans 530 the sorted segment list 600. If the scanning reaches the end of the list 540, the process is done. If the end of the list is not reached, the process decides if the segment is to be included 570 in the reconstructed codestream. If it is included, then the packets in this segment are written 580 as part of the reconstructed codestream. If the segment is not included, then an empty packet is written 590 as part of the reconstructed codestream. Then, the next segment in the sorted segment list is scanned, and the process repeats until all segments have been examined for inclusion in the reconstructed codestream 122.

The compose operation 500 essentially reconstructs a compliant codestream from segments that are not: necessarily compliant or meaningful to a decoder on their own.

Segment List

FIG. 6 shows the sorted segment list 600. This linked list contains a chain of ListElements 601 and Next pointers 602. Each ListElement contains a Header field 611 and Data 612 that point to the headers 401 of segments (packets) 402 of the segments 116.

Decompose/Compose Examples

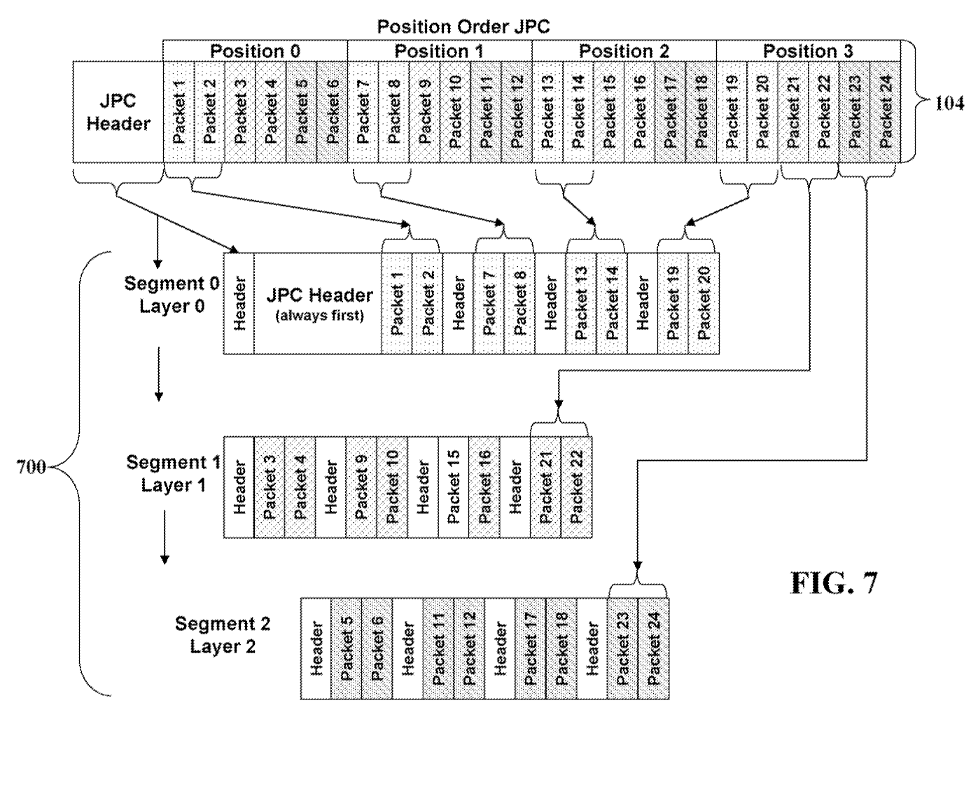

FIGS. 7-12 show various examples of progressive code streams according to embodiments of our invention. Because of the large number of fields reference numerals have been omitted for clarity. The named fields are as described above.

FIG. 7 shows packets reordered according to position (P) and quality layers (L). The input codestream 102 starts with a JPC header, which corresponds to the main header of a JPEG 2000 codestream, followed by packet 1 to packet 24. The first 6 packets correspond to position 0. Thus, all the information about position 0 is ordered first, and the codestream is referred to as being position-ordered. Packets {1, 2} describe quality layer 0 at position 0; packets {3, 4} describe quality layer 1 at position 0; and packets {5, 6} describe quality layer 2 at position 0. All the data for positions 1, 2 and 3 follow in the same format. Note a header precedes each set of numerically contiguous packets.

The input codestream is then decomposed into three segments 700 corresponding to three quality layers. Segment 0 Layer 0 starts with a segment header and is followed by the JPC header and packets {1, 2} from the input codestream. Next, another segment header is inserted followed by Packets {7, 8}. This pattern continues for subsequent position of the codestream data. This completes segment 0, which now contains all of quality layer 0 for all positions, ordered by position inside the particular segment.

Similarly, segment 1 Layer 1 contains all of quality layer 1 packets for all positions, ordered by position, and segment 2 Layer 2 contains all of quality layer 2 packets for all positions, ordered by position. These three segments are transmitted to the client in order.

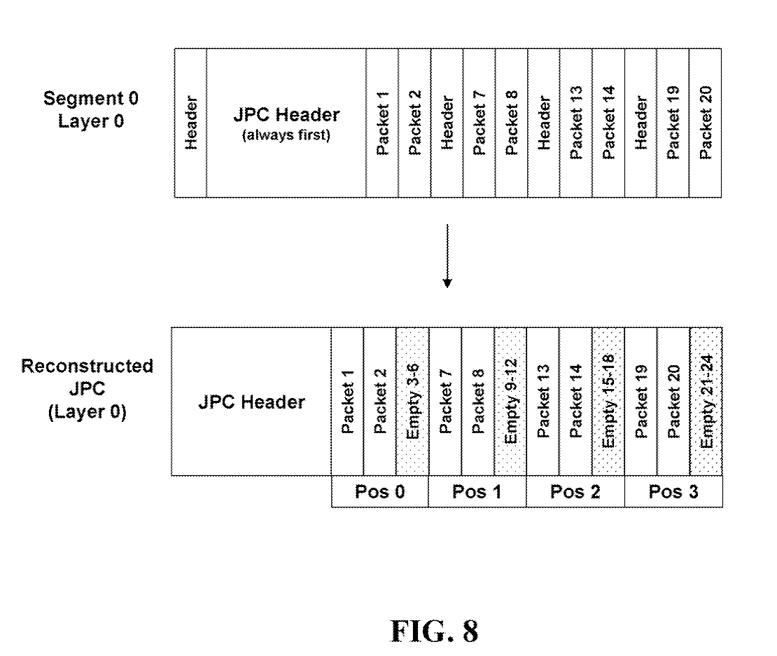

FIGS. 8-10 show the compose process for the decompose example described above. Segment 0 is received first by the client as shown in FIG. 8. Based on the segment header and the included codestream packets, the reconstructed codestream that corresponds to quality layer 0 of all positions is generated. The reconstructed codestream begins with the JPC main header then contains packets {1, 2, 7, 8, 13, 14, 19, 20}. Empty packets have been inserted for the missing packets {3-6, 9-12, 15-18, 21-24}. The result is a codestream that is fully compliant with the JPEG 2000 standard and only contains codestream data corresponding to quality layer 0 for all positions and empty packets for the other quality layers. Thus, the compressed image has been received at the client with quality layer 0 first, not position 0 first as encoded In the input codestream 102.

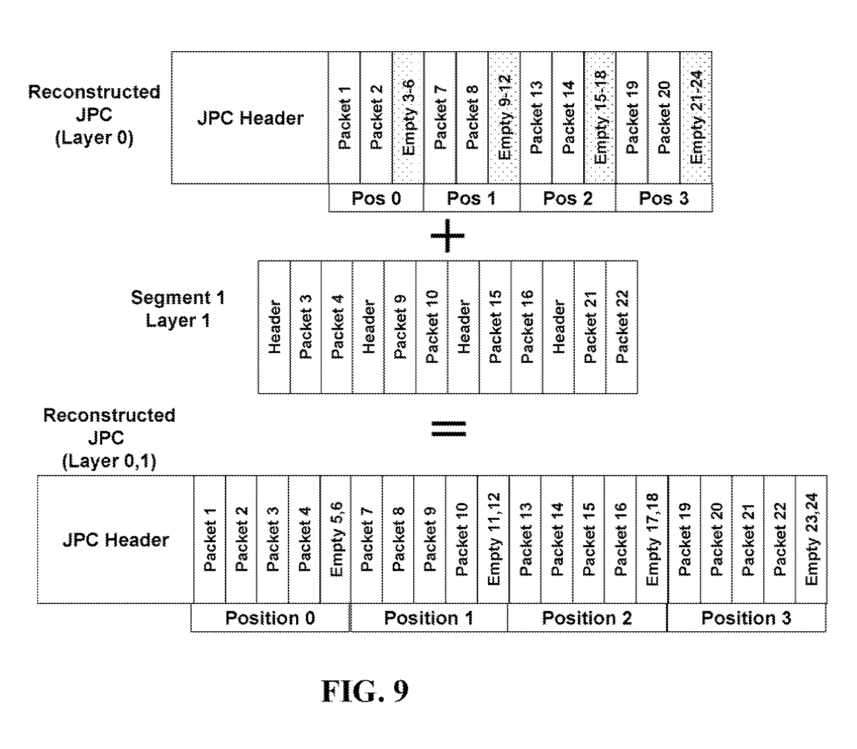

The compose process continues in FIG. 9 upon receiving segment 1. Based on the segment header and the included codestream data, the reconstructed codestream is augmented to include those packets that also correspond to quality layer 1 for all positions. In this case, the reconstructed codestream starts with the JPC main header then contains packets {1-4, 7-10, 13-16, 19-22}. Empty packets have been inserted for the missing packets {5, 6, 11, 12, 17, 18, 23, 24}. The result is a codestream that is fully compliant with the JPEG 2000 standard and only contains codestream data corresponding to quality layers 0 and 1 for all positions and empty packets for the other quality layers.

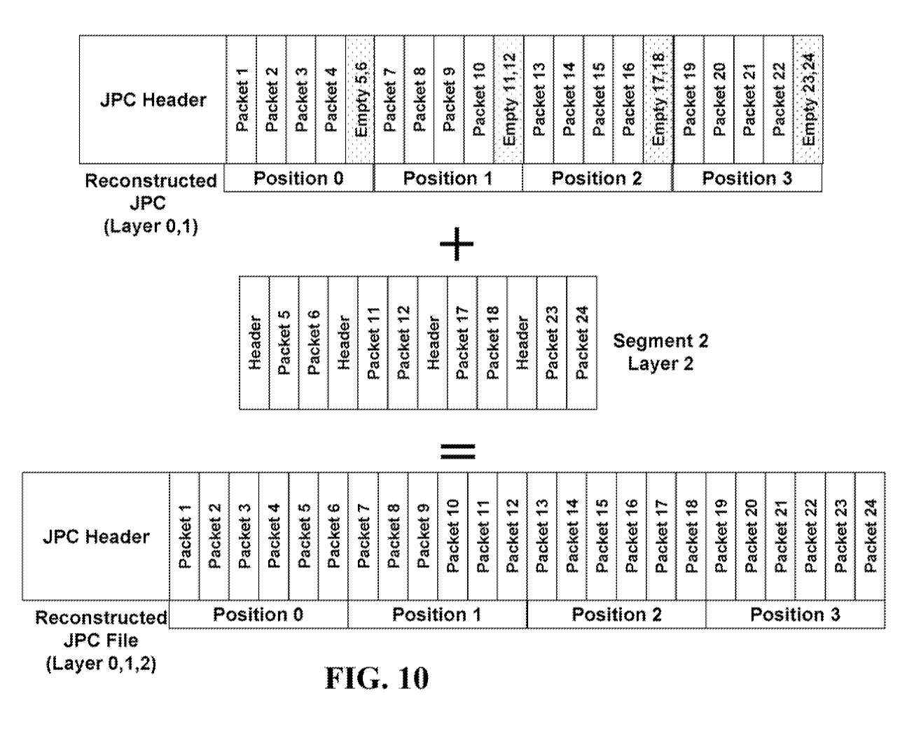

The final stage of the compose process is shown in FIG. 10, where segment 3 is received. Based on the segment header and the included codestream data, the reconstructed codestream is again augmented to include those packets that also correspond to quality layer 2 for all positions. After this process is complete, the reconstructed codestream includes all quality layers for all positions.

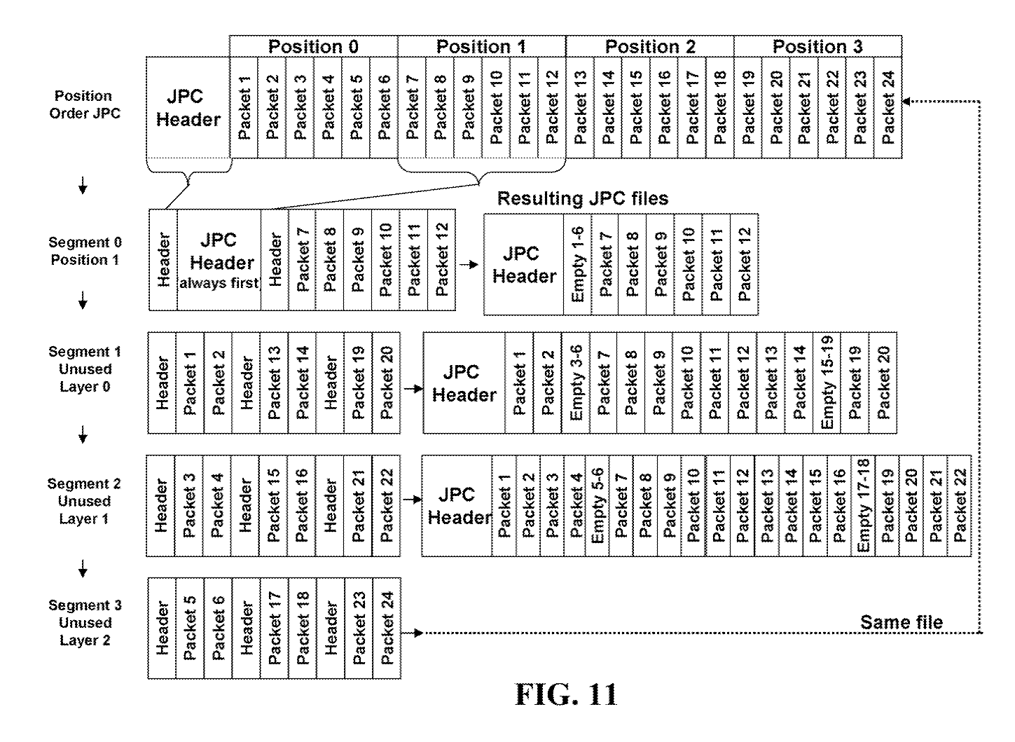

FIG. 11 shows an example of a position-ordered codestream that is decomposed in a mixed order, i.e., position 1 first, followed by layer-ordered segments. This example uses the same position-ordered codestream described in FIG. 7. The reconstructed codestreams for each stage of the progression are shown in FIG. 11 starting with position 1 packets in the first stage, an then followed by 3 quality layer segments including packets that correspond to the remaining positions. The final reconstructed codestream is again identical to the original input position-ordered codestream.

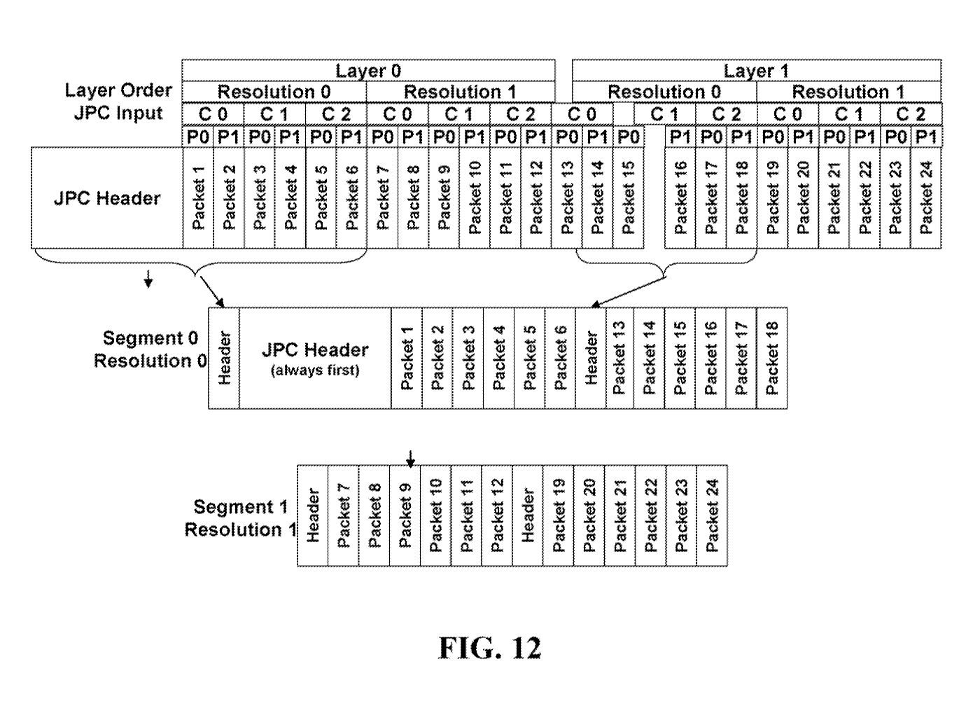

FIG. 12 shows an example where the progressive order is changed from a layer progressive codestream (LRCP) to resolution a progressive (RLCP). This example shows only two segments, where segment 0 contains only Resolution 0 and segment 1 contains only Resolution 1.

ROI Progressive Orders

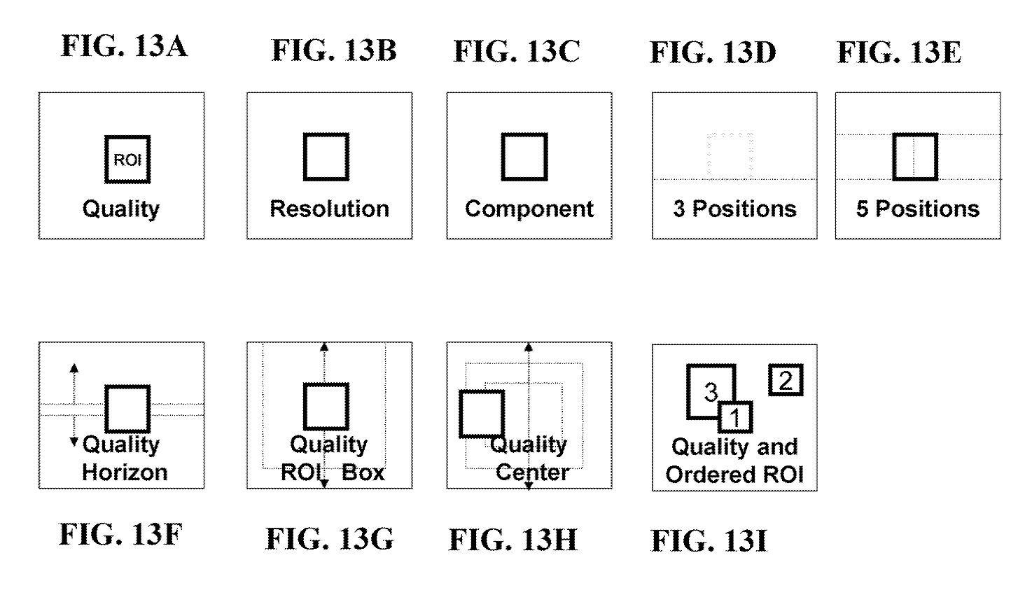

FIGS. 13A-13I show sample ROI progressions that are possible with the embodiments of the method according to the invention. FIG. 13A is a quality layer progression first inside the ROIs, then outside the ROI. FIG. 13B is a resolution progression first inside the ROIs, then outside the ROI. FIG. 13C is a component progression first inside the ROIs, then outside the ROI. FIG. 13D is a position progression first inside the ROIs, then two outside positions. FIG. 13E is a position progression first inside the ROIs, then four outside positions. FIG. 13F is a quality layer progression first inside the ROIs, then outside the ROI. FIG. 13G is a quality layer progression first inside the ROIs, then near the ROIs. FIG. 13H is a quality layer progression first inside the ROIs, then frame centered. FIG. 131 is a quality layer progression first inside the each ROI in order, then in the background.

The invention enables a server to prioritize the pixels in an image by reordering the image, or omitting portions of the image to reduce memory or bandwidth. This is important when images are large. The described method can also consider higher level knowledge acquired of the scene represented in the image(s) to determine the progressive ordering.

An example video shows a scene with an open cash register. The server application may decide to maintain full quality and resolution for those particular regions of the image covering the register with the open cash drawer. If a door has opened, the server may decide to give priority to that particular region of the image including the entrance area, and assign a lower priority to the regions when the door is closed. Multiple ROIs from different images can also be controlled by the server. A face detection application can assign a higher priority to a ROI when a new face is detected in the image. In another application, motion information is extracted from the image sequence. A motion-first ordering can be applied across all regions of the image. In this case, the server can apply a weighting to each candidate ROI of the image based on motion or other criteria.

### EFFECT OF THE INVENTION

The server-driven method for progressive image transmission has a low signaling overhead. Another effect of our invention allows fast incremental decoding and rendering of progressively received coded Images. In this invention, segments of coded images are transmitted. The first segment contains the main header. After the first segment has been received by the client, the client can insert empty packets for any missing packets that have not yet been received. This strategy allows the client to form a compliant JPEG 2000 codestream from partial codestreams even as the codestream is in the process of being received. This also makes the client resilient to dropped or missing packets due to transmission errors. The empty packet insertion at the client allows the server to reorder, suppress or discard portions of the coded image data to reduce transmission size or truncate coded image data.

An additional effect of the invention allows many different forms of progression. The invention describes a general solution that allows image data to be transmitted in many orders, thereby allowing the server to produce a nearly unlimited number of progressions. These can include simple frame orderings, or ROI first orderings or more complex mixed progressions. Moreover, when multiple ROIs are defined in the same image, the server has the flexibility to select different, priorities for each ROI, defining which ROI is sent first, and how much, bandwidth is allocated to each ROI, and the remaining part of the image.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method implemented in a server for generating a progressive codestream representing an image, the method comprising the steps of;
parsing a codestream of packets representing an image to obtain a parsed packets and metadata for each parsed packet;
decomposing the parsed packets to decomposed packets according to the metadata and a progressive transmission policy; and
assigning the decomposed packets to a plurality of sequentially arranged segments according to the metadata and the transmission policy, in which each segment includes a header, and in which an ordering of the packet in the codestream is different than an ordering of the decomposed packets in the plurality of segments.

2. The method of claim 1, in which the codestream is a JPEG 2000 codestream.

3. The method of claim 1, in which progressive transmission policy is determined by an application of the server.

4. The method of claim 1, in which the progressive transmission policy depends on system resources.

5. The method of claim 1, further comprising:
transcoding the parsed packets according to the metadata.

6. The method of claim 5, in which the transcoding performs a reordering of the parsed packets according to the progressive transmission policy.

7. The method of claim 1, further comprising:
transmitting progressively the plurality of sequentially arranged segments to a client.

8. The method of claim 7, further comprising:
composing the decomposed packets according to the header in the segments to progressively reconstruct the image in the client.

9. The method of claim 1, in which each block of numerically contiguous decomposed packets has the header.

10. The method of claim 1, in which the packets are numerically contiguous,

11. The method of claim 1, in which the metadata for each packet include a quality layer index, a resolution level index, a component index, and a precinct index.

12. The method of claim 9, in which the header encodes indexing information related to a location of the numerically contiguous decomposed packets in the segment.

13. The method of claim 9, in which the header encodes data size information for the numerically contiguous decomposed packets in the segment.

14. A system for generating a progressive codestream representing an image, comprising:
a server further comprising:
means for parsing a codestream of packets representing an image to obtain a parsed packets and metadata for each parsed packet;
means for decomposing the parsed packets to decomposed packets according to the metadata and a progressive transmission policy; and
means for assigning the decomposed packets to a plurality of sequentially arranged segments according to the metadata and the transmission policy, in which each segment includes a header, and in which an ordering of the packet in the codestream is different than an ordering of the decomposed packets in the plurality of segments.

15. The system of claim 14, further comprising:
a client further comprising:
means for composing the decomposed packets according to the header in the segments to progressively reconstruct the image in the client.
